(19) United States
(12) Patent Application Publication
(10) Pub. No.: US 2023/0403231 A1
(43) Pub. Date: Dec. 14, 2023

(54) STATIC DISPERSIVE ROUTING

(71) Applicant: CORNELIS NETWORKS, INC., WAYNE, PA (US)

(72) Inventors: Gary MUNTZ, Lexington, MA (US); Charles Archer, Wayne, PA (US)

(73) Assignee: CORNELIS NETWORKS, INC., WAYNE, PA (US)

(21) Appl. No.: 17/806,462

(22) Filed: Jun. 10, 2022

(51) Int. Cl. H04L 45/745; H04L 45/122; H04L 45/00

(52) U.S. Cl. CPC H04L 45/745; H04L 45/122; H04L 45/22

(57) ABSTRACT

Methods, systems, and products for static dispersive routing of packets in a high-performance computing (‘HPC’) environment are provided. Embodiments include generating an entropy value; receiving, by a switch, a plurality of packets, where each packet includes a header with the entropy value and a destination local identifier (‘DLID’) value; and routing, by the switch in dependence upon the entropy value and the DLID value, the packets to a next switch in order.

### BACKGROUND

High-Performance Computing (‘HPC’) refers to the practice of aggregating computing in a way that delivers much higher computing power than traditional computers and servers. HPC, sometimes called supercomputing, is a way of processing huge volumes of data at very high speeds using multiple computers and storage devices linked by a cohesive fabric. HPC makes it possible to explore and find answers to some of the world's biggest problems in science, engineering, business, and others.

Various high-performance computing systems support topologies with interconnects that can support both dynamic routing and static routing. Static routing creates a fixed routing pattern for a flow across a fabric such that the packets of any given flow stay in order. Routing decisions that are static often include not only the set of switches visited by a packet but also the links or parallel cables in use between a pair of switches. Furthermore, various high-performance computing systems also support topologies with interconnects that can support both minimal and non-minimal hops along paths and flows between sources and destinations and endpoints while keeping the packets in-order. Packets remain in-order if all packets follow the same order of switches and links between hops.

It would be advantageous to have an efficient and effective mechanism to provide static routing between a source and destination or endpoint to endpoint and determine whether to use a minimal or non-minimal hop and maintain which of parallel cables to use for a flow, such that each flow remains in-order. In-order packet processing has strong semantic benefits in some cases and is often more efficient for a receiving node to process.

### BRIEF DESCRIPTION OF THE DRAWINGS

Many aspects of the present disclosure can be better understood with reference to the following drawings. The components in the drawings are not necessarily to scale, with emphasis instead being placed upon illustrating the principles of the disclosure. Moreover, in the drawings, like reference numerals designate corresponding parts throughout the several views.

FIG. 1 sets forth a system diagram of an example high-performance computing environment useful in static dispersive routing according to some embodiments of the present invention.

FIG. 2 sets forth a HyperX topology useful with and benefitting from static dispersive routing according to embodiments of the present invention.

FIG. 3 sets forth a Dragonfly topology useful with and benefitting from static dispersive routing according to embodiments of the present invention.

FIG. 4 sets forth a MegaFly topology useful with and benefitting from static dispersive routing according to embodiments of the present invention.

FIG. 5 sets forth a Fat Tree topology useful with and benefitting from static dispersive routing according to embodiments of the present invention.

FIG. 7 sets forth a block diagram of an example switch.

FIG. 8 sets forth an example structure for a packet header

FIG. 9 sets forth a flow chart illustrating an example method of static dispersive routing of packets in a high-performance computing (‘HPC’) environment according to embodiments of the present invention.

FIG. 10 sets forth a line drawing of aspects of static dispersive routing according to example embodiments of the present invention.

FIG. 11 sets forth a line drawing of an example of static dispersive routing according to example embodiments of the present invention.

FIG. 12 sets forth a line drawing of an example of static dispersive routing according to example embodiments of the present invention.

### DETAILED DESCRIPTION

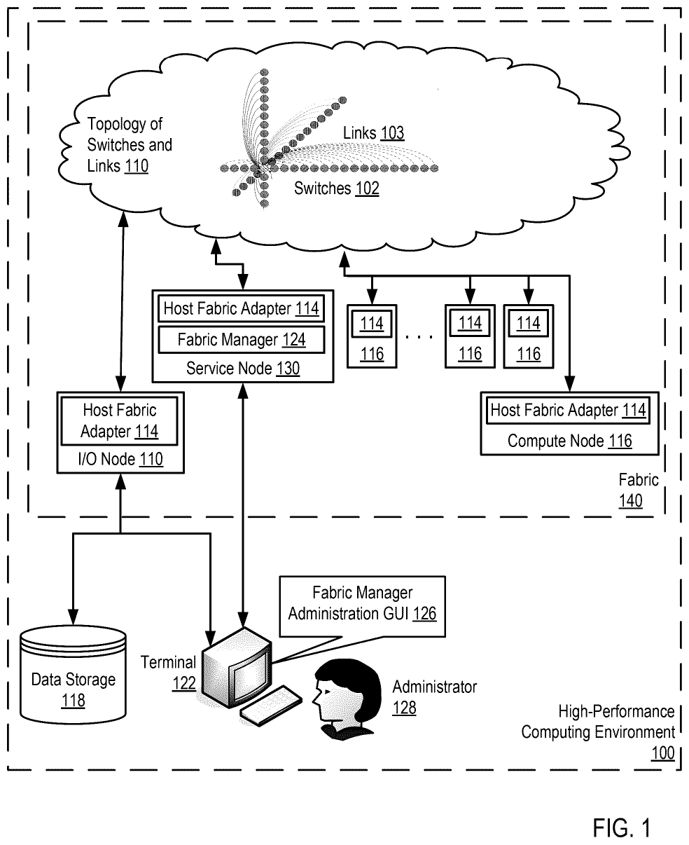

Methods, systems, and products for static dispersive routing of packets in a high-performance computing (‘HPC’) environment are described with reference to the attached drawings beginning with FIG. 1. FIG. 1 sets forth a system diagram of an example high-performance computing environment (100) useful in static dispersive routing according to some embodiments of the present invention. Static dispersive routing according to embodiments of the present invention supports both exascale fabrics, as well as smaller fabrics. Embodiments of the present invention disperse packet traffic over the fabric to both maximize bandwidth and minimize congestion. Preferably, in the case of multi-coordinate fabrics, such dispersion will occur over as many coordinates as possible. Use of as many coordinates as possible this increases the dispersion of the routes which increases utilization of all resources and decreases vulnerability to congestion.

In embodiments implementing all-to-all coordinates, static dispersive routing according to the present invention makes use of static routing with both minimal paths and non-minimal paths. As explained in more detail below, static dispersive routing in the example of FIG. 1 operates generally by generating an entropy value, receiving, by a switch, a plurality of packets, where each packet includes a header with the entropy value and a destination local identifier (‘DLID’) value and routing, by the switch in dependence upon the entropy value and the DLID value, the packets to a next switch in order. By routing the packets in-order the routing is static and because each hop will be either minimal or non-minimal to take advantage of the fabric the routing is also dispersive. The example high-performance computing environment of FIG. 1 includes a fabric (140) which includes an aggregation of a service node (130), an Input/Output I/O node (110), a plurality of compute nodes (116) each including a host fabric adapter (‘HFA’) (114), and a topology (110) of switches (102) and links (103). The service node (130) of FIG. 1 provides service common to pluralities of compute nodes, loading programs into the compute nodes, starting program execution on the compute nodes, retrieving results of program operations on the compute nodes, and so on. The service node of FIG. 1 runs a service application and communicates with administrators (128) through a service application interface that runs on computer terminal (122). Administrators typically use the fabric manager to configure the fabric, and the nodes themselves, as required. Users (not depicted) often interact with one or more applications but not the fabric manager. As such, the fabric manager is used only by privileged administrators, running on specific nodes, because of the security implications of configuring the fabric.

The fabric (140) according to the example of FIG. 1 is a unified computing system that includes interconnected nodes that often look like a weave or a fabric when seen collectively. In the example of FIG. 1, the fabric (140) includes compute nodes (116), host fabric interfaces (114) and switches (102). The switches (102) of FIG. 1 are coupled for data communications to one another with links to form one or more topologies (110). The example of FIG. 1 illustrates a HyperX topology discussed in more detail below.

The compute nodes (116) of FIG. 1 operate as individual computers including at least one central processing unit (‘CPU’), volatile working memory and non-volatile storage. The compute nodes of FIG. 1 are connected to the switches (102) and links (103) through a host interface adapter (114). The hardware architectures and specifications for the various compute nodes vary and all such architectures and specifications are well within the scope of the present invention as will occur to those of skill in the art. Such non-volatile storage may store one or more applications or programs for the compute node to execute. Such non-volatile storage may be implemented with flash memory, rotating disk, hard drive or in other ways of implementing non-volatile storage as will occur to those of skill in the art.

As mentioned above, each compute node (116) in the example of FIG. 1 has installed upon it or is connected for data communications with a host fabric adapter (114) (‘HFA’). Host fabric adapters according to example embodiments of the present invention deliver high bandwidth and increase cluster scalability and message rate while reducing latency. The example HFA (114) of FIG. 1 connects a host such as a compute node (116) to the fabric (140) of switches (102) and links (103). The HFA adapts packets from the host for transmission through the fabric. The example HFA of FIG. 1 provides matching between the requirements of applications and fabric, maximizing scalability and performance. The HFA of FIG. 1 provides increased application performance including dispersive routing and congestion control.

The switches (102) of FIG. 1 are multiport modules of automated computing machinery, hardware and firmware, that receive and transmit packets. Typical switches (102) receive packets, inspect packet header information, and transmit the packets according to routing tables configured in the switch. Often switches are implemented as or with one or more application specific integrated circuits (‘ASICs’). In many cases, the hardware of the switch implements packet routing and firmware of the switch configures routing tables, performs management functions, fault recovery, and other complex control tasks as will occur to those of skill in the art.

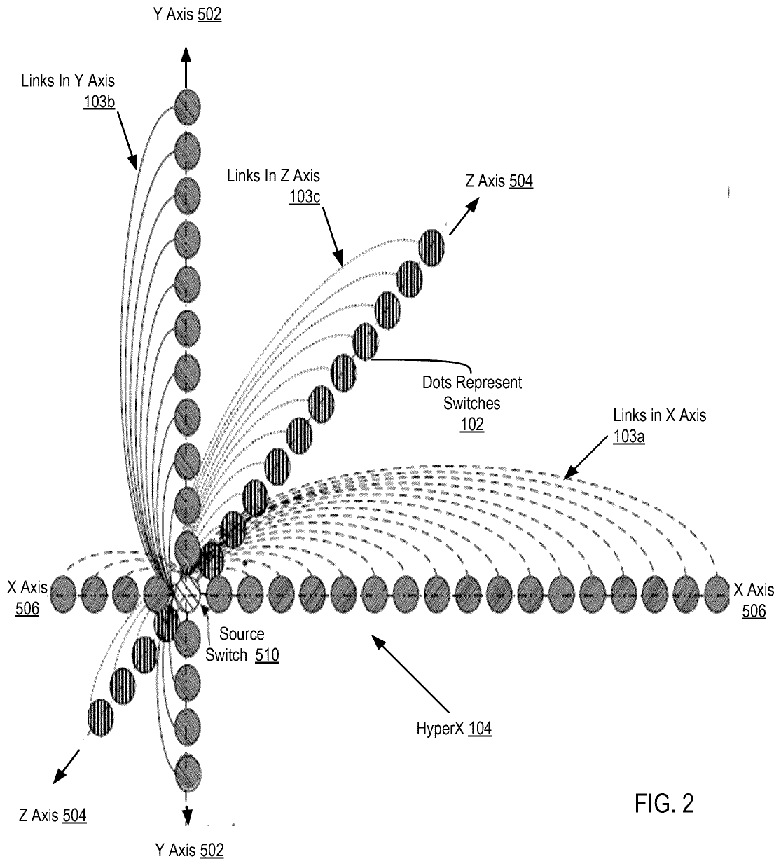

The switches (102) of the fabric (140) of FIG. 1 are connected to other switches with links to form one or more topologies (110). A topology according to the example of FIG. 1 is the connectivity pattern among switches, HFAs, and the bandwidth of those connections. Compute nodes, HFAs, switches and other devices, and switches may be connected in many ways to form and many topologies, each designed to perform in ways optimized for their purposes. Example topologies useful in static dispersive routing according to example embodiments of the present invention include a HyperX (104), Dragonfly (106), MegaFly (112), Fat Tree (108), and many others as will occur to those of skill in the art. Examples of HyperX (104), Dragonfly (106), MegaFly (112), and Fat Tree (108) topologies are discussed below with reference to FIGS. 2-5. The configuration of compute nodes, service nodes, I/O nodes, and many other components vary in various topologies as will occur to those of skill in the art.

The service node (130) of FIG. 1 has installed upon it a fabric manager (124). The fabric manager (124) of FIG. 1 is a module of automated computing machinery for configuring, monitoring, managing, maintaining, troubleshooting, and otherwise administering elements of the fabric (140). The example fabric manager (124) is coupled for data communications with a fabric manager administration module with a graphical user interface (‘GUI’) (126) allowing administrators (128) to configure and administer the fabric manager (124) through a terminal (122) and in so doing configure and administer the fabric (140). In some embodiments of the present invention, static routing algorithms used for static dispersive routing are controlled by the fabric manager (124) which configures static routes from endpoint to endpoint. Such static routes may use minimal or non-minimal hops along the path from endpoint to endpoint as discussed in more detail below.

Routes according to embodiments of the present invention include the transmission of packets from one node or switch to another. The header of packets useful in static dispersive routing according to embodiments of the present invention often include at least an entropy value and a destination local identifier (‘DLID’). An entropy value according to embodiments of the present invention is a specification of details of a static route through the fabric (140). In concert with a DLID, the entropy value describes the complete route, including use of non-minimal paths and which of ports to use in multi-port links.

In-order and static routing may be considered as a flow of packets with the same entropy value and DLID that all follow the same path, traversing the same buffers, from one node or switch to another along the same links. This routing keeps the flow in order. That is, the packets of the flow arrive at the destination endpoint in the order they were transmitted. This in-order behavior is important for the semantics of many kinds of communication between nodes.

A flow may be identified by a flow ID. As discussed in more detail below, a flow ID may be implemented as an identifier, such as a number, identifying all of the packets of a “flow”. The precise definition of that flow depends on the configuration of fields that the flow is based upon. That said, flow ID's according to embodiments of the present invention are often implemented as a unique value for the set of packets exchanged between one entity and another. An entity may be fine-grained, exposing differences among many flows between endpoints. As such, in some embodiments, as the variety of flow ID increases, the effectiveness of static dispersive routing according to embodiments of the present invention also increases.

Static dispersive routing according to some embodiments of the present invention is largely controlled by two fields in the packet header-entropy value, and destination local identifier (‘DLID’). Both fields may be configured by the fabric manager (126) but as discussed below the entropy value may also be calculated and assigned by other entities in the fabric. For each coordinate in a topology, a subfield in the DLID identifies which switch to route to and the entropy value specifies how to reach that switch. The coordinates along a path are traversed in a fixed static order in many embodiments. Alternatively, another field controls the flow of packets. In such embodiments, the order of packet transmission is fixed per coordinate specification field (‘cspec’). Furthermore, different flows can have different Cspecs and therefore different coordinate orders.

The example of FIG. 1 includes an I/O node (110) responsible for input and output to and from the high-performance computing environment. The I/O node (110) of FIG. 1 is coupled for data communications to data storage (118) and a terminal (122) providing information, resources, GUI interaction and so on to an administrator (128).

As discussed above, a number of topologies are useful with and benefit from static dispersive routing according to embodiments of the present invention. While most of this disclosure is oriented toward a HyperX topology discussed in more detail below, embodiments and aspects of the present invention may usefully be deployed on a number of topologies as will occur to those of skill in the art.

For further explanation, FIG. 2 sets forth a topology useful with and benefitting from static dispersive routing according to embodiments of the present invention. The topology of FIG. 2 is implemented as a HyperX (104). In the example of FIG. 2, each dot (102) in the HyperX (104) represents a switch. Each switch (102) is connected by a link (103). The HyperX topology of FIG. 2 is depicted as an all-to-all topology in three dimensions having an X axis (506), a Y axis (502), and a Z axis (504).

The use of three dimensions in the example of FIG. 2 is for example and explanation, not for limitation. In fact, a HyperX topology may have many dimensions with switches and links administered in a manner similar to the simple example of FIG. 2.

In the example of FIG. 2, one example switch is described as the source switch (510). The example source switch (510) of these three dimensions is directly connected with every switch in the topology. The designation of the source switch (510) is for explanation and not for limitation. Each switch in the example of FIG. 2 may be connected to other switches in a similar manner and thus each switch may itself be a source switch. That is, the depiction of FIG. 2 is designed to illustrate a HyperX topology with non-trivial scale from the perspective of a single switch-labeled here as the source switch (510). A fuller fabric may have similar connections for all switches. For example, a set of switches may be implemented as a rectangular volume of many switches with all-to-all connectivity.

Each switch (102) is connected to all of the others in each coordinate via a link (103). These connections are only to switches sharing a position within a coordinate. FIG. 2 is drawn to show only those switches which are directly interconnected. The set of switches in this fabric is really a 3-dimensional rectangular volume filled with switches, but the ones lacking direct links (103) to the example switch (510) are hidden for clarity. An analogous connection pattern exists for every switch in this topology.

The example of FIG. 2 illustrates an expansive all-to-all network of switches implementing a HyperX topology but for simplicity only illustrating a single link between each of the switches. In HyperX, K is the terminology for the number of parallel links (103) between two individual switches (102). K=1 establishes connectivity between the switches, and K>1 increases the bandwidth of that connection with more links. As discussed below, when K>1, static dispersive routing according to embodiments of the present invention implement a static route and use the same link for all packets of a flow for a hop from one switch to another so as to remain in order.

Static dispersive routing according to the example of FIG. 2 operates generally in a HyperX topology by generating an entropy value, receiving, by a switch (102), a plurality of packets, where each packet includes a header with an entropy value and a destination local identifier (‘DLID’) value and routing, by the switch in dependence upon the entropy value and the DLID value, the packets to a next switch in order.

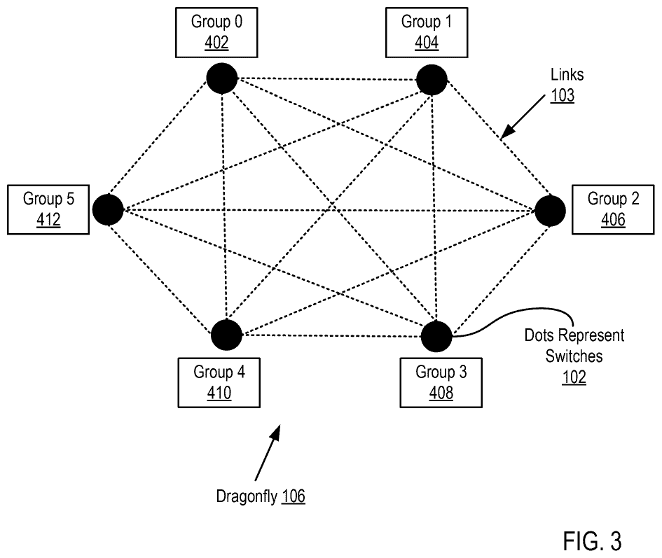

Another topology both useful with and benefitting from static dispersive routing according to example embodiments of the present invention is Dragonfly. FIG. 3 sets forth a line drawing illustrating a set of switches (102) and links (103) implementing a Dragonfly topology. The example Dragonfly topology of FIG. 3 is provided for ease of explanation and not for limitation. In fact, the Dragonfly topology has many variants such as Canonical Dragonfly and others as will occur to those of skill in the art.

The example Dragonfly topology of FIG. 3 is depicted in a single dimension and is implemented as an all-to-all topology meaning that each switch (102) is directly connected to each switch (102) in the topology. The Dragonfly topology is typically defined as a direct topology in which each switch accommodates a set of connections leading to endpoints, and a set of topological connections leading to other switches. The Dragonfly concept often relies on the notion of groups (402-412) that themselves having a collection of switches. A collection of switches belonging to the same group are connected with intra-group connections, while switch pairs belonging to different groups are connected with inter-group connections. In some deployments, switches and associated endpoints belonging to a group are assumed to be compactly colocated in a very limited number of chassis or cabinets. This permits intra-group and terminal connections with short-distance and lower-cost electrical transmission links. In many cases, inter-group connections are based on optical equipment that is capable of spanning the tens of meters inter-cabinet distances.

Modularity is one of the main advantages provided by the Dragonfly topology. Thanks to the clear distinction between intra- and inter-group links, the final number of groups present within one HPC environment often does not affect the wiring within a group.

Static dispersive routing according to the example of FIG. 3 operates generally in a Dragonfly topology by generating an entropy value, receiving, by a switch (102), a plurality of packets, where each packet includes a header with an entropy value and a destination local identifier (‘DLID’) value and routing, by the switch in dependence upon the entropy value and the DLID value, the packets to a next switch in order.

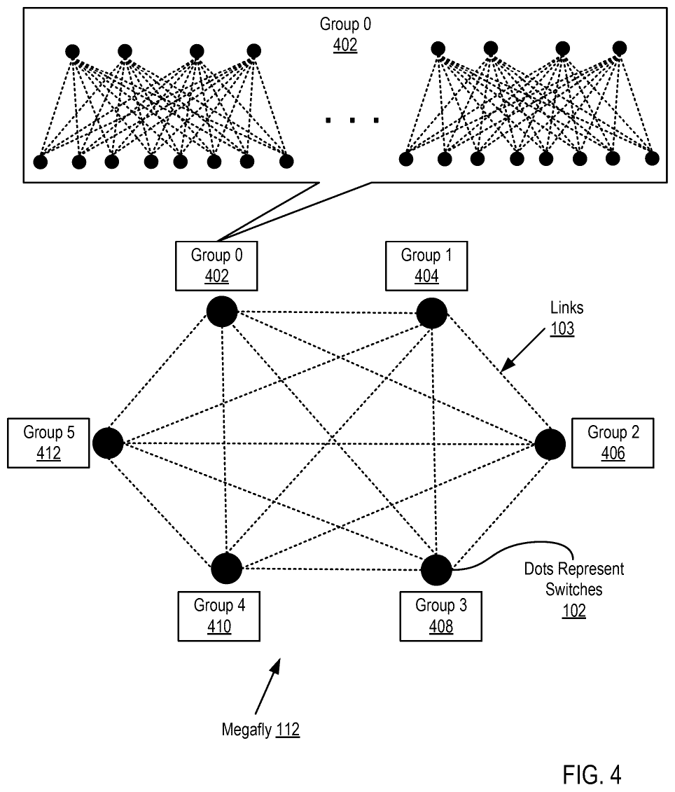

For further explanation, FIG. 4 sets forth another topology both useful with and benefitting from static dispersive routing according to embodiments of the present invention. The topology of FIG. 4 is implemented as a MegaFly (112). The MegaFly (112) topology of FIG. 4 is an all-to-all topology of switches (102) and links (103) among a set of groups-Group 0 (402), Group 1 (404), Group 2 (406), Group 3 (408), Group 4 (410), and Group 5 (412). In the example MegaFly topology of FIG. 4, within each group (402-412) is itself another topology of switches and links implemented as a two-tier fat tree (402). This configuration is illustrated as Group 0 (402) in this example.

Static dispersive routing in the example of FIG. 4 operates generally in a MegaFly topology by generating an entropy value, receiving, by a switch (102), a plurality of packets, where each packet includes a header with an entropy value and a destination local identifier (‘DLID’) value and routing, by the switch in dependence upon the entropy value and the DLID value, the packets to a next switch in order.

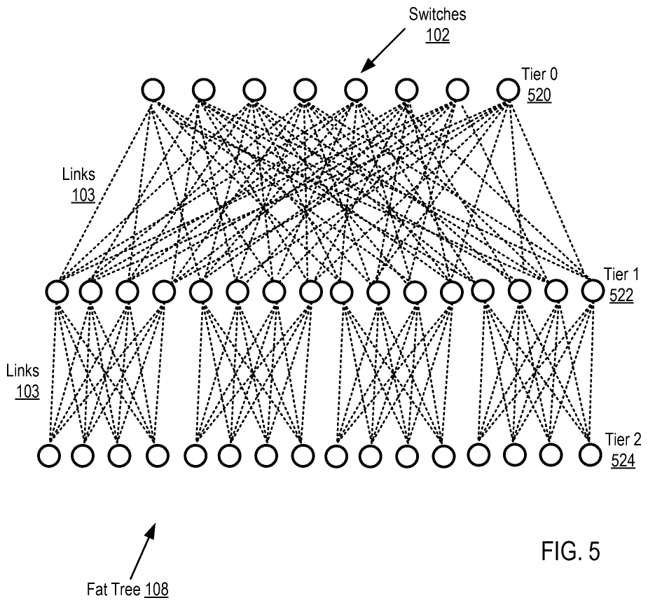

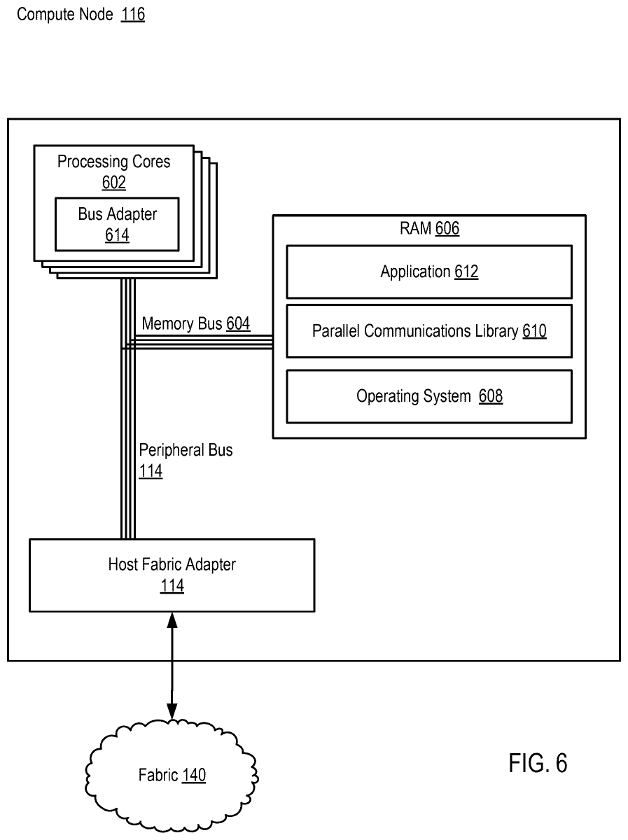

While not an all-to-all topology such as HyperX, DragonFly, and MegaFly, FIG. 5 sets forth a line drawing of a topology implementing a Fat Tree (108). A Fat Tree is a topology which may benefit from static dispersive routing according to some particular embodiments of the present invention. In a simple tree data structure, every branch has the same thickness, regardless of their place in the hierarchy-they are all “skinny”—that is low-bandwidth. However, in a fat tree, branches nearer the top of the hierarchy are “fatter” than branches further down the hierarchy because they have more links (103) to other switches (102) and therefore provide more bandwidth. The varied thickness (bandwidth) of the data links allows for more efficient and technology-specific use.

In the example of FIG. 5, each dot (102) in the Fat Tree (108) represents a switch. Each switch (102) is connected by a link (103). The number of links (202) at the top hierarchy of the tree provide more bandwidth. There are fewer links (204) one tier below between switches and therefore represent less bandwidth. As the number of tiers increases, the bandwidth between switches in a Fat Tree often decreases.

Static dispersive routing in the example of FIG. 5 operates generally in a Fat Tree topology by generating an entropy value, receiving, by a switch (102), a plurality of packets, where each packet includes a header with an entropy value and a destination local identifier (‘DLID’) value and routing, by the switch in dependence upon the entropy value and the DLID value, the packets to a next switch in order.

For further explanation, FIG. 6 sets forth a block diagram of a compute node useful in static dispersive routing according to embodiments of the present invention. The compute node (116) of FIG. 6 includes processing cores (602), random access memory (‘RAM’) (606) and a host fabric adapter (114). The example compute node (116) is coupled for data communications with a fabric (140) for high-performance computing. The fabric (140) of FIG. 6 is implemented as a unified computing system that includes interconnected nodes, switches, links, and other components that often look like a weave or a fabric when seen collectively. As discussed above, the nodes, switches, links, and other components, of FIG. 6 are also implemented as a topology—that is, the connectivity pattern among switches, HFAs, and the bandwidth of those connections.

Stored in RAM (606) in the example of FIG. 6 is an application (612), a parallel communications library (610), and an operating system (608). Common uses for high-performance computing environments often include applications for complex problems of science, engineering, business, and others.

A parallel communications library (610) is a library specification for communication between various nodes and clusters of a high-performance computing environment. A common protocol for HPC computing is the Message Passing Interface (‘MPI’). MPI provides portability, scalability, and high-performance. MPI may be deployed on many distributed architectures, whether large or small, and each operation is often optimized for the specific hardware on which it runs. The application (612) of FIG. 6 is capable of generating an entropy value for static dispersive routing according to embodiments of the present invention as discussed in more detail below. In such cases, a fabric manager often provides topology information to the application describing the fabric itself. The application calculates an entropy value in dependence upon the topology information provided by the fabric manager.

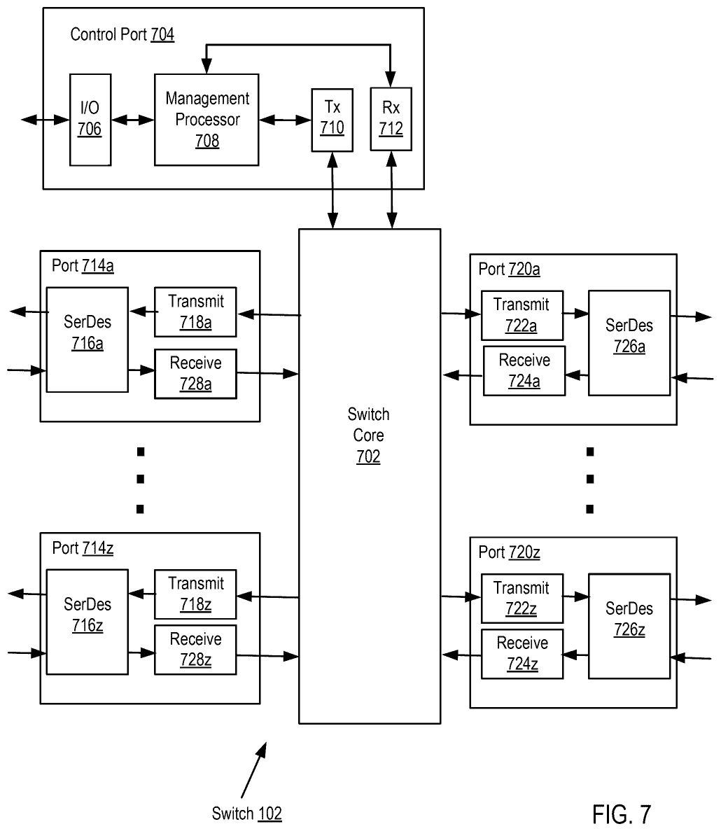

For further explanation, FIG. 7 sets forth a block diagram of an example switch. The example switch (102) of FIG. 7 includes a control port (704), a switch core (702), and a number of ports (714a-714z) and (720a-720z). The control port (704) of FIG. 7 includes an input/output (‘I/O’) module, a management processor (708), and a transmission (710) and reception (712) controllers. The management processor (708) of the example switch of FIG. 7 maintains and updates routing tables for the switch to use in static dispersive routing according to embodiments of the present invention. In the example of FIG. 7, each receive controller maintains the latest updated routing tables. As discussed in more detail below, the receive controllers of FIG. 7 are capable of generating an entropy value in hardware according to embodiments of the present invention.

The example switch (102) of FIG. 7 includes a number of ports (714a-714z and 720a-720z). The designation of reference numeral 714 and 720 with the alphabetical appendix of a-z is to explain that there may be many ports connected to a switch. Switches useful in static dispersive routing according to embodiments of the present invention may have any number of ports-more or less than 26 for example. Each port (714a-714z and 720a-720z) is coupled with the switch core (702) and has a transmit controller (718a-718z and 722a-722) and a receive controller (728a-728 and 724a-724z).

Each port in the example of FIG. 7 also includes a Serializer/Deserializer (716a-716z and 726a-726z). A Serializer/Deserializer (‘SerDes’) is a pair of functional blocks commonly used in high-speed communications to compensate for limited input/output. These blocks convert data between serial data and parallel interfaces in each direction. The primary use of a SerDes is to provide data transmission over a single line or a differential pair in order to minimize the number of I/O pins and interconnects.

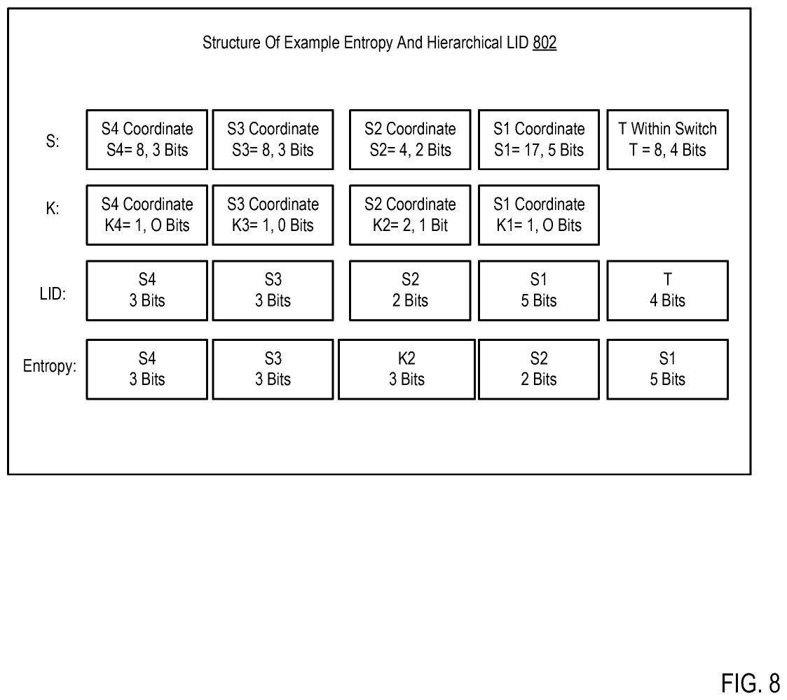

For further explanation FIG. 8 sets forth an example structure for a packet header including and entropy value and a hierarchical LID in four dimensions, S4, S3, S2, S1. The example of FIG. 8 designates each dimension S4, S3, S2, S1 and allocates a number of bits for its description. The example of FIG. 8 also includes a designation of a link (K) for each coordinate S4, S3, S2, S1 and allocates a number of bits for its description. The example of FIG. 8 also includes a local identifier (‘LID’) for each dimension S4, S3, S2, S1 and allocates a number of bits for its description. The example of FIG. 8 also includes an entropy value that describes how a packet is to be routed in each coordinate and on which link to transmit the packet as discussed in more detail below.

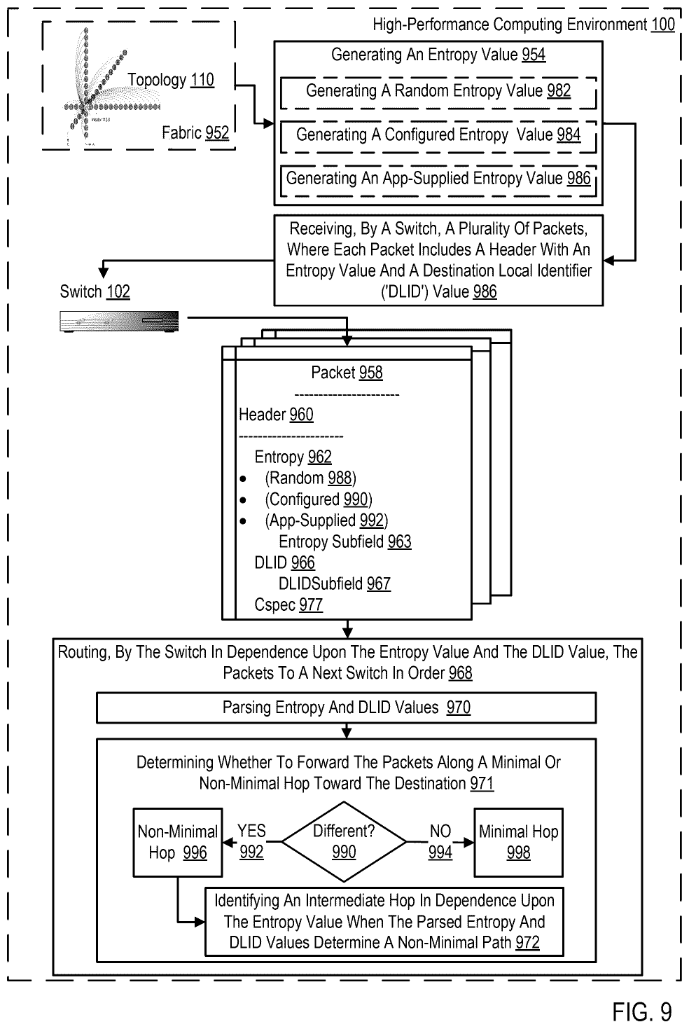

For further explanation, FIG. 9 sets forth a flow chart illustrating an example method of static dispersive routing of packets in a high-performance computing (‘HPC’) environment according to embodiments of the present invention. The HPC computing environment (100) of FIG. 9 includes a fabric (952) that in turn includes a topology (110) of a plurality of switches and links. In the example of FIG. 9, the illustrated topology (110) is a HyperX topology useful in many embodiments of the present invention. As mentioned above, the present disclosure is described often with reference to a HyperX topology. This is for explanation and not for limitation. In fact, embodiments and aspects of the present invention may be implemented in a number of topologies as will occur to those of skill in the art.

The method of FIG. 9 includes generating (954) an entropy value; receiving (986), by a switch (102), a plurality of packets (958), where each packet (958) includes a header (960) with the entropy value (962) and a destination local identifier (‘DLID’) value (966); and routing (968), by the switch (102) in dependence upon the entropy value (962) and the DLID value (966), the packets (958) to a next switch in order. As mentioned above, at a high level, static dispersive routing according to embodiments of the present invention operates generally in dependence upon two fields of the packet header (960): entropy (962) and destination LID (DLID) (966). The entropy value (962) specifies a static route through the fabric (952). In concert with the DLID (966), the entropy value (962) describes the complete route, including use of non-minimal paths and which of K ports to use in multi-port links. Both fields and their values are generated per coordinate in a topology. For each coordinate, the corresponding subfield (967) of the DLID (966) indicates which switch to route to, and the corresponding subfield (963) of entropy (962) specifies how to reach that switch. The coordinates are traversed in fixed order to avoid credit loops also known as a “deadlock.”

Entropy is often defined unidirectionally. That is, in such embodiments, there is no requirement that a response travel a path related to its request. Often the DLID and entropy values per coordinate are developed by a fabric manager in accordance with the details of the specific deployment. Alternatively, DLID (966) and entropy (962) may be generated per coordinate by an application having topology information presented by the fabric manager. In many of these embodiments, the fabric manager generates the rules for entropy generation (such as maximum value per subfield) and configures the HFA to enforce these rules. The application can then deliver an entropy value through an API with the packet to the HFA, and if it's compliant with the rules the packet is transmitted. Furthermore, because the fabric manager can control the entropy values, it may tailor the distribution of resources they consume. For example, a bias toward or away from minimal routes may be created. This kind of administration can further be influenced as part of a quality-of-service model. For example, the HFA may be configured to allocate only non-minimal paths to storage traffic.

As mentioned above, the value K represents the number of parallel links between two individual switches. K=1 establishes connectivity between the switches and K>1 increases the bandwidth of that connection. When K>1, it's important that a static route use the same link of K for all packets of a flow, otherwise they will not remain in order.

In the case of K=1, meaning a single link between switches in a given coordinate, the width of entropy subfields (963) and DLID subfields (967) are the same. Each is wide enough to specify the coordinate of any switch in that coordinate. The DLID subfield provides the destination switch coordinate and the entropy subfield provides the intermediate switch for the nonminimal case. The minimal routing case is signaled by the two subfields having the same value.

When K>1, the entropy field must be wider than the corresponding DLID field width to encode which K as well as the intermediate group switch coordinate. However, this does not mean that the maximum entropy field width is larger than the maximum width of the DLID subfields. Some large deployments have K=1 so the maximum DLID width, excluding the function field, is typically wide enough for the maximum entropy field. The widths may differ in smaller deployments, where the DLID can shrink but entropy will remain near its maximum size.

The method of FIG. 9 includes generating (954) an entropy value. Generating (954) an entropy value may be carried out by calculating an entropy value and encoding the entropy value in the header of a packet for static dispersive routing according to embodiments of the present invention. As discussed above, entropy may be calculated in more than one way and by more than one entity in the high-performance computing environment supporting the static dispersive routing. Entropy may be implemented in both hardware and software and calculations of entropy include random entropy, configured entropy, and application-supplied entropy, described below as well as other calculations of entropy as will occur to those of skill in the art. For explanation, the entropy value (962) has an indication of the method of its calculation shown as bullet points with parenthetical references. That is, the entropy value (962) in the example of FIG. 9 may be implemented with random entropy (988), configured entropy (990), application-supplied entropy (992) and so on. Such entropy calculations are not mutually exclusive and may be used in a hierarchical order as discussed above.

As mentioned above, a flow ID is an identifier identifying all the packets of a “flow”. The precise definition of a flow depends on the configuration of fields it's based upon, but at a high level it is a unique value for the set of packets exchanged between one entity and another. The notion of ‘entity’ is preferably fine-grained, exposing differences among many flows between endpoints. As varieties in flow ID increase so does the effectiveness of static dispersive routing according to embodiments of the present invention.

In some architectures, such as for example, an Omni-Path architecture, a list of fields in the packet header (“OPA fields”) are available to the flow ID calculation. These include destination LID (DLID) including the function field; MPI Rank, Tag and Context, and others as will occur to those of skill in the art. As mentioned above, a common protocol for HPC computing is the Message Passing Interface (‘MPI’). MPI provides portability, scalability, and high-performance. MPI may be deployed on many distributed architectures, whether large or small, and each operation is often optimized for the specific hardware on which it runs.

MPI uses the concept of a communicator which is a communication universe for a group of processes. Each process in a communicator is identified by its rank. The rank value is used to distinguish one process from another. Messages are sent with an accompanying user-defined integer tag, to assist the receiving process in identifying the message. Messages can be screened at the receiving end by specifying a specific tag. A context is essentially a system-managed tag (or tags) needed to make a communicator safe for point-to-point and MPI-defined collective communication.

In addition to extracting the flow ID from the packet headers, randomness may also be added to the flow ID when the flow is marked to enable out-of-order delivery. For packets with route control (RC) in the header, this indication is the most significant bits of that field and may be enabled by an algorithm number in the lower bits of RC matching a constant from the fabric manager.

Turning now to the calculation of entropy values, the examples above show the foundation of entropy value calculation for the simple case of a fabric without faults or illegal combinations of subfield values. In this example, entropy is primarily used for traffic to an HFA and the rules are as follows:
All subfields shall be independently calculated based on separate hash results
All subfields destined to an HFA are zero-based

For the simple example of a 2-dimensional HyperX, pseudocode for the entropy subfields may be implemented with the following: hash_rand( ) is a function that pulls a slice of the hash result of the flow ID calculation and converts it to a pseudorandom number scaled by its argument, producing an integer between 0 and (argument−1). Because the hash itself is pseudorandom, hash_rand( ) may be implemented with a multiply and round to achieve the scaling specified by the argument.
Entropy_S1=hash_rand(17)
Entropy_S2=hash_rand(4)
Entropy_K2=hash_rand(2)

In many embodiments, entropy is calculated to avoid faults in the fabric which modifies the entropy value calculation per dimension, and this modification depends on the value of K in that dimension. Entropy alone or entropy may be hashed with other fields. The hash produces a unique value per flow and all the bits of the hash are variable per flow so that any subset of the hash is useful as a flow identifier for selection of a different, that is, dispersive path through the fabric.

As mentioned above, the generating (954) an entropy value (962) may be done in software or offloaded to hardware. In the example of FIG. 9, generating (954) an entropy value (962) may be carried out by generating (982) a random entropy value (988). Random entropy (988) may be calculated in both hardware and software. Software implemented random entropy (988) may include having a driver available to the application assign entropy within the header for a packet. The assigned entropy is based on fabric manager configuration of entropy values and HLID in terms of the width and maximum value of each subfield. A hash of the upper-level header fields can be arithmetically converted to an entropy value. A hash of the header fields identifying a flow may then be sliced into subfields, each of which is multiplied by a constant to produce a value per subfield which has a legal value. In some embodiments, because the operations are independent per dimension, parallel execution units for each dimension are used.

Generating (982) a random entropy value (988) may also be carried out in hardware. The same algorithm used for random entropy generation in software may be implemented in hardware. The logic for entropy value calculation, including the fault handling, can be parallelized per dimension. All of these attributes point to efficient offload to dedicated ASIC logic. Such hardware implementation may reduce the cache of values and reduces concerns of thrashing at scale. Hashing of the flow ID is also small and efficient in hardware and should be included in this offload. To avoid the cost of a multiplier circuit for the hash_rand( ) function, we can leverage the variable-sized (random) number generator used in fine-grained adaptive routing (FGAR) logic. The packet field hash result is divided into ‘subrandom’ values as input to this logic, based on a fabric manager configuration, such that the output values cover the range of 0 to configured maximum for each subfield.

Generating (954) an entropy value (962) may be carried out by generating (984) a configured entropy value (990) in software. Configured entropy (9900 must be table-based. In such cases, the fabric manager generates complete entropy values that are valid for a given destination switch. The scale of these is significant in a large fabric, so offloading the state to host memory is advantageous for HFA architecture. One way to reduce the size of these tables may be implemented by combining configured with random entropy generation. For example, if the configured entropy table has no value for a flow ID, the random entropy value calculation is used. In such cases, the hashing of the flow ID is carried out in software because it precedes the table lookup. Management datagrams (‘MAD’) packet processing supports significant volume of writes from a fabric manager to these tables.

Generating (954) an entropy value (962) may also be carried out by generating (984) a configured entropy value (990) in hardware. Configured entropy generation in hardware is considered straightforward so long as the entropy table fits on die.

Generating (954) an entropy value (962) may be carried out by generating (986) an application-supplied entropy (992). In the case of application software having the ability to generate routes for a set of flows, accepting these routes is straightforward for the HFA. This can be used in concert with configured and/or random entropy generation for other flows. In one case, an application-supplied entropy value can be supported first, then if no entropy value is provided for a packet, configured entropy tables would be checked for a value from the fabric manager, and if none is found, random entropy would be generated. This is all amenable to hardware implementation if the configured entropy tables fit on die or can work with software implementations as discussed above.

As mentioned above, a common protocol for HPC computing is the Message Passing Interface (‘MPI’). Generating an application supplied entropy may be carried out in dependence of MPI Rank, Tag and Context. As mentioned above, the rank value is used to distinguish one process from another. Messages can be screened at the receiving end by specifying a specific tag and a context is essentially a system-managed tag (or tags) needed to make a communicator safe for point-to-point and MPI-defined collective communication.

The entropy value should be checked for legality and should be checked for faults. There may be other controls that the fabric manager may administer in the entropy values delivered in such embodiments. Hardware support for application supplied entropy may include includes extending extend the offloads for random and configured entropy as the checks.

The method of FIG. 9 also includes receiving (956), by a switch (102), a plurality of packets (958), where each packet (958) includes a header (960) with an entropy value (962) and a destination local identifier (‘DLID’) value (966). Receiving (956), by a switch (102), a plurality of packets (958), where each packet (958) includes a header (960) with an entropy value (962) and a destination local identifier (‘DLID’) value (966) includes receiving through one or more ports of a switch a plurality of packets in order for transmission in the fabric in order as specified by the entropy value and the DLID value.

The method of FIG. 9 also includes routing (968), by the switch (102) in dependence upon the entropy value (962) and the DLID value (966), the packets (958) to a next switch in order. In the example of FIG. 9, routing (968), by the switch (102) in dependence upon the entropy value (962) and the DLID value (966), the packet to a next switch includes parsing (970) entropy and DLID values and determining (971) whether to forward the packets along a minimal or non-minimal hop toward the destination.

Determining (971) whether to forward the packets along a minimal or non-minimal hop toward the destination may be carried out by comparing (990) entropy values (962) for a current dimension with the DLID coordinate (966) for the same dimension. If they are different (992) then a non-minimal hop is instructed by the entropy value. The example of FIG. 9 therefore includes identifying (972) an intermediate hop in dependence upon the entropy value (962) when the parsed entropy (972) and DLID values (970) determine a non-minimal hop. The intermediate hop is identified by the entropy subfield (963). If entropy values (962) for a current dimension with the DLID coordinate (966) for the same dimension are the same a minimal hop (988) is instructed.

When a switch receives a packet indicating use of the static dispersive routing according to embodiments of the present invention, the DLID, entropy value, and perhaps subfields are parsed according to configuration from the fabric manager. The dimension to send the packet may be determined from a coordinate specification field (‘Cspec’) (977). The entropy values for the current dimension are compared with the DLID coordinate for the same dimension. If they are different then a non-minimal path is instructed by the entropy value, via an intermediate hop through the switch at the coordinate provided by the entropy subfield. If the present switch is not at the entropy coordinate, then the packet is sent to the entropy coordinate-following the first hop in this dimension. If the present switch is the same as the entropy value coordinate, then the packet must take the second hop, so send it to the coordinate in the DLID. In both cases the entropy value's K value in this dimension should be honored.

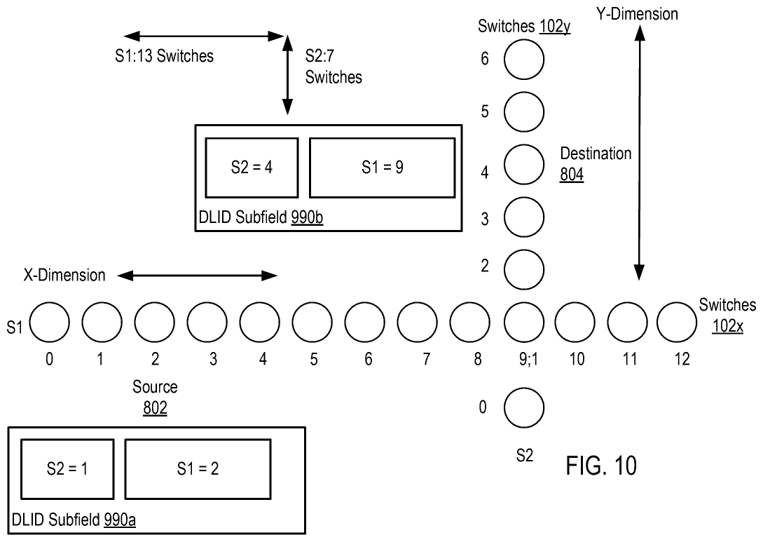

For further explanation, FIG. 10 sets forth a line drawing of aspects of static dispersive routing according to example embodiments of the present invention. The example of FIG. 10 includes a number of switches (102x, 102y) arranged in two dimensions and depicted as a circle. In the X dimension (902), designated as S1 in the DLID subfield (990b and (990a), there are 13 switches (102x), and also designated as switches 0-12. In the Y dimension, designated as S2, there are 7 switches (102y), switches 0-6. The destination LID address includes subfields (990a and 990b) that include per coordinate direction. As such, a packet transmitted from the source (802) at switch (S1:2) will be transmitted to destination (804) at switch (S2:4). A packet so transmitted in the example of FIG. 10, is transmitted through switch (9;1). In the example of FIG. 10, the DLID subfield (990a) identifies the source (802) in the X dimension as SI=2 and also the switch which is switch 1 in the Y dimension as S2=1. Similarly, the DLID subfield (990b) identifies the origin switch (9;1) in the X dimension as S1=9 and the destination switch (804) in the Y dimension, switch 4, as S2=4.

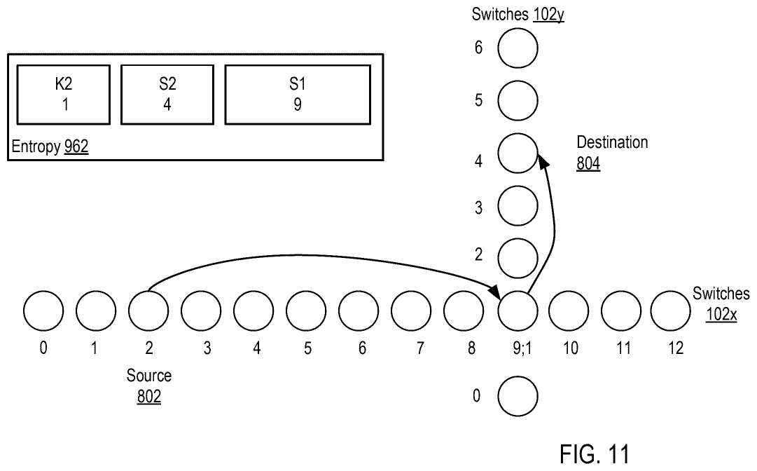

For further explanation, FIG. 11 sets forth a line drawing of an example of static dispersive routing according to example embodiments of the present invention. The example of FIG. 11 includes the same switches as the example of FIG. 10 and the example of FIG. 11 depicts the transmission of a packet from the source (802) to the destination (804) through switch (9;1). The example of FIG. 11 uses the DLID subfields discussed with reference to FIG. 10 and adds the use of an entropy value (962) that specifies how to transmit the packet from the source (802) switch 2 in the X dimension (102x) to the destination (804) switch 4 in the Y dimension (102y). The entropy value (962) specifies how a packet will be sent from the source (802) to a destination (804) by identifying switch 9 (S1=9) which is the intermediate switch (9;1), the particular link K2 identifying a link in the Y dimension and the destination switch (804) which is S2=4.

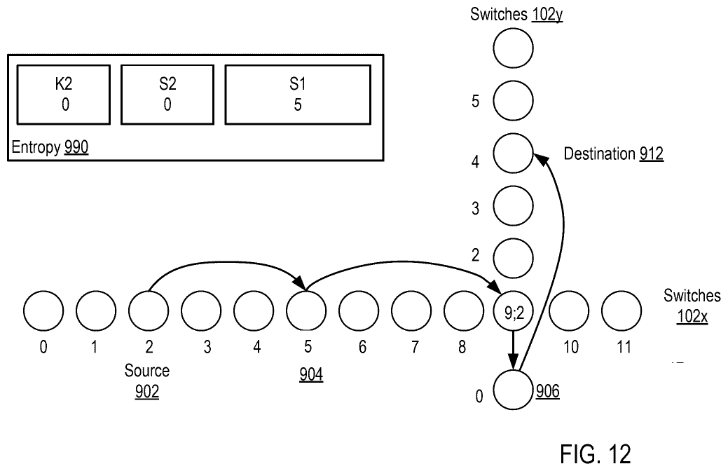

As will occur to those of skill in the art, the transmission of a packet from source (802) to destination (804) is a minimal hop from the source to destination as the transmission passes through the least number of switches between source (804) and destination (804). Static dispersive routing according to embodiments of the present invention also supports non-minimal hops. As such, for further explanation, FIG. 12 sets forth a line drawing of an example of static dispersive routing according to example embodiments of the present invention. The example of FIG. 12 includes the same switches as the example of FIG. 10 and the example of FIG. 10 and depicts the transmission of a packet from the source (802) to the destination (804) through switch (9;1) in a non-minimal manner. The example of FIG. 12 uses the DLID subfields discussed with reference to FIG. 10 and adds the use of an entropy value (990) that specifies how to transmit the packet from the source (802) switch 2 in the X dimension (102x) to the destination (804) switch 4 in the Y dimension (102y).

The entropy value (990) of FIG. 10 specifies how a packet will be sent from the source (802) to the destination (804). The packet in the example of FIG. 10 will be sent from the source (802) to switch 5 (904) in the X dimension by identifying switch 5 (S1=5) and the next switch along the non-minimal hop which is switch 0 (906) in Y dimension which travels through the origin (9;1). The entropy value also includes the identification of the link K2=0 in the Y dimension upon which to transmit the packet.

The examples of static dispersive routing described with reference to FIGS. 10-12 are for explanation and not for limitation. Static dispersive routing according to embodiments of the present invention may be deployed on many topologies, with many dimensions and minimal and non-minimal hops may include many more switches as will occur to those of skill in the art.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of static dispersive routing of packets in a high-performance computing (‘HPC’) environment, the HPC computing environment including a fabric comprising a topology of a plurality of switches and links, the method comprising:
generating an entropy value;
receiving, by a switch, a plurality of packets, where each packet includes a header with the entropy value and a destination local identifier (‘DLID’) value; and
routing, by the switch in dependence upon the entropy value and the DLID value, the packets to a next switch in order.

2. The method of claim 2 wherein generating an entropy value further comprises generating a random entropy value.

3. The method of claim 2 wherein generating an entropy value further comprises generating a configured entropy value.

4. The method of claim 2 wherein generating an entropy value further comprises generating an application-supplied entropy value.

5. The method of claim 1 wherein routing, by the switch in dependence upon the entropy value and the DLID value, the packet to a next switch includes parsing entropy and DLID values and determining whether to forward the packets along a minimal or non-minimal hop toward the destination.

6. The method of claim 5 wherein determining whether to forward the packets along a minimal or non-minimal path further comprises by comparing an entropy value for a current dimension with the DLID coordinate for the same dimension.

7. The method of claim 5 further comprising identifying an intermediate hop in dependence upon the entropy value when the parsed entropy and DLID values determine a non-minimal hop.

8. The method of claim 5 wherein the fabric comprises a plurality of dimensions and the packet header includes a dimension value and wherein routing, by the switch in dependence upon the entropy value and the DLID value, includes identifying the next destination switch to route the packet in dependence upon the dimension value.

9. The method of claim 8 wherein the dimension value is contained in a coordinate specification (‘Cspec’) field of the packet header.

10. The method of claim 8 wherein each packet header further includes a dimension order value and identifying the next destination switch to route the packet in dependence upon the dimension order value further comprises selecting an output port for the packet in dependence upon the dimension order value.

11. The method of claim 1 wherein the entropy value comprises a hashed pseudorandom value.

12. The method of claim 3 wherein the entropy value is calculated by a fabric manager.

13. The method of claim 4 wherein the entropy value is calculated by an application in dependence upon information describing the fabric provided by a fabric manager.

14. The method of claim 13 wherein the application calculates the entropy value in dependence upon a rank, tag, and context value.

15. A system of static dispersive routing of packets in a high-performance computing (‘HPC’) environment, the HPC computing environment including a fabric comprising a topology of a plurality of switches and links, the system comprising automated computing machinery configured for:
generating an entropy value;
receiving, by a switch, a plurality of packets, where each packet includes a header with the entropy value and a destination local identifier (‘DLID’) value; and
routing, by the switch in dependence upon the entropy value and the DLID value, the packets to a next switch in order.

16. The system of claim 15 further configured for routing, by the switch in dependence upon the entropy value and the DLID value, the packets to a next switch including parsing entropy and DLID values and determining whether to forward the packets along a minimal or non-minimal hop toward the destination.

17. The system of claim 15 wherein the entropy value is generated by a fabric manager.

18. The system of claim 15 wherein the entropy value is generated by an application in dependence upon information describing the fabric provided by a fabric manager.

19. The system of claim 18 wherein the application generates the entropy value in dependence upon a rank, tag, and context value.

20. The system of claim 15 wherein the entropy value comprises a hashed pseudorandom value.
